(19) United States
(12) Patent Application Publication
(10) Pub. No.: US 2016/0282674 A1
(43) Pub. Date: Sep. 29, 2016

(54) METHOD OF MANUFACTURING LIQUID CRYSTAL DEVICE, LIQUID CRYSTAL DEVICE, AND ELECTRONIC APPARATUS

(71) Applicant: Seiko Epson Corporation, Tokyo (JP)

(72) Inventors: Koichi Takemura, Chino-shi (JP); Shohei Yoshida, Shimosuwa-machi (JP); Hiroyuki Abe, Matsumoto-shi (JP)

(21) Appl. No.: 15/081,442

(22) Filed: Mar. 25, 2016

(30) Foreign Application Priority Data
Mar. 27, 2015 (JP) 2015-066734
Dec. 21, 2015 (JP) 2015-248275

(51) Int. Cl. G02F 1/1337

(52) U.S. Cl. CPC G02F 1/133719

(57) ABSTRACT

Provided is a method of manufacturing a liquid crystal device including a liquid crystal layer interposed between a pair of substrates in which an alignment layer that is formed of an organosilane compound, and a porous layer provided under the alignment layer are formed on a surface, which faces the liquid crystal layer, of at least one of the pair of substrates. The method includes applying a coating solution containing the organosilane compound, to a surface of the porous layer; forming a coated film, in a state in which the coating solution infiltrates into the porous layer; drying the coated film; and baking the coated film. The alignment layer is formed, on the surface of the porous layer, to have a thickness less than a diameter of a hole in the porous layer.

### BACKGROUND

1. Technical Field

The present disclosure relates to a method of manufacturing a liquid crystal device, a liquid crystal device, and an electronic apparatus.

2. Related Art

Recently, with the wide use of digital signage (electronic signage), there has been a demand for liquid crystal display element (liquid crystal device) for display having an increased light resistance service life.

A liquid crystal display element requires an alignment layer which controls the alignment of liquid crystal. For example, a polysiloxane-based vertical alignment material has been proposed for use as an alignment layer with high light resistance properties (refer to International Publication No. 2007/102513). However, the liquid crystal display element which uses the polysiloxane-based vertical alignment material for the alignment layer is susceptible to burn-in.

Meanwhile, an alignment layer which is formed by chemical adsorption of organosilane molecules onto a substrate is known (refer to Japanese Liquid Crystal Society Journal “Liquid Crystal”, Vol. 16, No. 3 (2012) P 197 to 204). The alignment layer formed of the organosilane compound is characterized by being firmly bonded to the substrate and is formed of an ultrathin film on the order of nanometers (nm). In addition, it is possible to obtain the effect of suppressing burn-in by forming the alignment layer as an ultrathin film.

In addition, it has been proposed that a surface of an inorganic alignment film formed by using an oblique deposition method be processed with a silane coupling material (organosilane compound) (refer to JP-A-2007-127757). JP-A-2007-127757 describes that a vapor phase method and a liquid phase method can be used for surface processing performed by silane coupling.

However, in the case where a coating method of the liquid phase method is used, C10 (decyltrimethoxysilane) concentrated as a solvent volatilizes in a film forming step, and thus, a polymerization reaction of the organosilane compound is performed. At this time, a gap on the order of nm between columns in an inorganic alignment film may be filled with an organosilane polymer. Therefore, a pre-tilt angle of liquid crystal molecules may not be produced.

In addition, it has been proposed that an alignment film (alignment layer) formed of the organosilane compound be formed on an underlying film (porous layer) formed of an inorganic compound and include multiple holes (refer to JP-A-2007-328251 and JP-A-2006-30843).

However, in the case where the alignment layer formed of the organosilane compound is formed by using, for example, a spin-coating method, a dip-coating method, or a coating method such as a flexo printing method, a coating solution containing organosilane molecules spattered onto a formation surface agglomerates into droplets. In the case where the agglomerated droplets are solidified as is, the droplets remain on a surface of the formed alignment layer, and thus, alignment of a liquid crystal layer may fail and display defects may be visible.

In addition, JP-A-2007-328251 and JP-A-2006-30843 disclose that an alignment layer formed of the organosilane compound is formed on a porous layer (inorganic alignment layer formed by using an oblique deposition method). For example, a vapor phase reaction can be used in a method of manufacturing an alignment layer formed of the organosilane compound.

Specifically, a substrate in which an inorganic alignment film is formed is inserted into a film forming chamber, and furthermore, a vaporized organosilane compound and moisture are supplied to the film forming chamber. Then, a hydroxyl group on a surface of the inorganic alignment film reacts with the organosilane compound, and thereby a chemical bond thereof is made. In this way, it is possible to form an alignment layer on a surface of an inorganic alignment film by using a vapor phase reaction.

However, if a large amount of the organosilane compound is formed on a surface of an inorganic alignment film, unreacted organosilane compound is accumulated, and thereby a gap on the order of nm between columns in the inorganic alignment film may be filled with the organosilane compound. Accordingly, a pre-tilt angle of liquid crystal molecules may not be produced, and alignment of a liquid crystal layer may fail. Therefore, problems of visible display defects and burn-in may occur.

### SUMMARY

An advantage of some embodiments are to provide a method of manufacturing a liquid crystal device, a liquid crystal device, and an electronic apparatus in which occurrence of burn-in is suppressed by forming an alignment layer of an ultrathin film on a surface of a porous layer.

A method of manufacturing a liquid crystal device according to some embodiments are a method of manufacturing a liquid crystal device. The method includes providing a substrate which includes a porous layer on a surface of the substrate, applying a coating solution containing a organosilane compound to a surface of the porous layer, forming a coated film in a state in which the coating solution infiltrates the porous layer, drying the coated film; and baking the coated film so as to be formed an alignment layer on the surface of the porous layer, in which the alignment layer having a thickness less than a diameter of a hole in the porous layer.

According to the manufacturing method, the coating solution containing the organosilane compound infiltrates the porous layer by capillary action. At this time, the thickness of the coated film formed on a surface of the porous layer is less than the diameter of a hole in the porous layer, and thus, it is possible to prevent the coating solution applied to the surface of the porous layer from agglomerating into droplets. Accordingly, it is possible to form the coated film containing the organosilane compound on the surface of the porous layer as an ultrathin film. Thereafter, the coated film is dried and baked, and thus, it is possible to form the alignment layer with a thickness less than the diameter of the hole in the porous layer, on the surface of the porous layer, in a state in which the organosilane compound infiltrates the porous layer. Hence, according to the manufacturing method, an ultrathin alignment layer can be formed on the surface of the porous layer, and thus, it is possible to suppress occurrence of burn-in in the manufactured liquid crystal device.

In the manufacturing method, it is preferable that the porous layer be formed by using a sol-gel method.

According to the manufacturing method, it is possible to form the porous layer by using a simple method.

In the manufacturing method, it is preferable that the average thickness of the alignment layer be 1 nm to 10 nm.

According to the manufacturing method, the alignment layer containing the organosilane compound can be formed as an ultrathin film, and thus, it is possible to obtain the effect of suppressing occurrence of burn-in in the manufactured liquid crystal device.

In the manufacturing method, it is preferable that the average diameter of the hole be 2 nm to 50 nm.

According to the manufacturing method, it is possible to realize infiltration properties sufficient for the coating solution containing the organosilane compound to infiltrate the porous layer by capillary action without adversely affecting the alignment control of the liquid crystal layer by the alignment layer.

In the manufacturing method, it is preferable that an inorganic oxide film selected from SiO₂, SnO₂, GeO₂, ZrO₂, TiO₂, Al₂O₃, and ITO be formed as the porous layer.

According to the manufacturing method, it is possible to increase light resistance life and to firmly fix the organosilane compound contained in the alignment layer to the inorganic oxide film.

A liquid crystal device according to another aspect of some embodiments includes a substrate which includes a porous layer on a surface of the substrate, and an alignment layer formed on a surface of the porous layer, the alignment layer includes a organosilane compound, in which the organosilane compound is infiltrated in the porous layer, and a thickness of the alignment layer is less than the diameter of a hole in the porous layer.

According to the configuration, an ultrathin alignment layer can be formed on the surface of the porous layer, and thus, it is possible to suppress occurrence of burn-in in the liquid crystal device.

In the liquid crystal device, the porous layer may form at least a part of an electrode.

According to the configuration, by forming at least a part of the electrode as the porous layer, the porous layer need not be formed in addition to the electrode in the portion, and thus, costs can be reduced.

An electronic apparatus according to still another aspect of some embodiments includes a liquid crystal device manufactured by using any one of the methods, or any one of the liquid crystal devices.

According to the configuration, it is possible to provide an electronic apparatus including a liquid crystal device which can suppress occurrence of burn-in.

A method of manufacturing a liquid crystal device according to still another aspect of some embodiments is a method of manufacturing a liquid crystal device includes providing a substrate which includes a porous layer on a surface of the substrate, and performing a vapor phase reaction of gas which contains the organosilane compound so as to be formed an alignment layer on the surface of the porous layer, on a surface of the porous layer, in which the alignment layer having a thickness less than a diameter of a hole in the porous layer.

According to the manufacturing method, the alignment layer having a thickness less than the diameter of a hole in the porous layer is formed, and thus, it is possible to chemically bond the organosilane compound in which the vapor phase reaction is performed on the surface (for example, with an hydroxyl group) of the porous layer, and to suppress accumulation of unreacted organosilane compound on the surface of the porous layer. Hence, it is possible to form an ultrathin alignment layer on the surface of the porous layer and to suppress occurrence of burn-in in the manufactured liquid crystal device.

In the manufacturing method, it is preferable that the porous layer be formed by using an oblique deposition method.

According to the manufacturing method, it is possible to form the porous layer by using a simple method.

In the manufacturing method, it is preferable that the average thickness of the alignment layer be 1 nm to 10 nm.

According to the manufacturing method, the alignment layer containing the organosilane compound can be formed as an ultrathin film, and thus, it is possible to obtain the effect of suppressing occurrence of burn-in in the manufactured liquid crystal device.

In the manufacturing method, it is preferable that the average diameter of the hole be 2 nm to 50 nm.

According to the manufacturing method, it is possible to chemically bond the vaporized organosilane compound to the surface (for example, to an hydroxyl group) of the porous layer, and to suppress accumulation of the unreacted organosilane compound on the surface of the porous layer without adversely affecting the alignment control of the liquid crystal layer by the alignment layer.

In the manufacturing method, it is preferable that an inorganic oxide film selected from SiO₂, SnO₂, GeO₂, ZrO₂, TiO₂, Al₂O₃, and ITO be formed as the porous layer.

According to the manufacturing method, it is possible to increase a light resistance life and to firmly fix the organosilane compound contained in the alignment layer to the inorganic oxide film.

In the manufacturing method, it is preferable that isopropyl alcohol (IPA) cleaning be performed at least before or after the alignment layer is formed.

According to the manufacturing method, it is possible to remove any residue (unreacted organosilane compound or the like) attached to the surface of the porous layer from a surface of the substrate.

An electronic apparatus according to still another aspect of some embodiments includes a liquid crystal device manufactured by using any one of the methods.

According to the configuration, it is possible to provide an electronic apparatus including a liquid crystal device in which occurrence of burn-in can be reduced.

### BRIEF DESCRIPTION OF THE DRAWINGS

The disclosure will be described with reference to the accompanying drawings, wherein like numbers reference like elements.

FIG. 1 is an equivalent circuit diagram illustrating an element structure of a liquid crystal device according to an embodiment.

FIG. 2 is a plan view illustrating a configuration of a pixel group in a TFT array substrate included in the liquid crystal device of FIG. 1.

FIG. 3 is a sectional view illustrating an element structure of the liquid crystal device of FIG. 1.

FIG. 4 is a sectional view illustrating a configuration of a pixel region of the liquid crystal device of FIG. 1.

FIG. 5 is a sectional view schematically illustrating a structure of a porous layer and an alignment layer of the liquid crystal device of FIG. 1.

FIG. 6 is a sectional view illustrating a step of forming the alignment layer.

FIG. 7 is a sectional view illustrating the step of forming the alignment layer.

FIG. 8 is a sectional view illustrating the step of forming the alignment layer.

FIG. 9 is a sectional view illustrating the step of forming the alignment layer.

FIG. 10 is a perspective view illustrating an example of an electronic apparatus according to the embodiment.

FIG. 11 is a perspective view illustrating an example of the electronic apparatus according to the embodiment.

FIG. 12 is a perspective view illustrating an example of the electronic apparatus according to the embodiment.

FIG. 13 is a schematic view illustrating an example of a projection type liquid crystal display device according to the embodiment.

FIG. 14 is a sectional view schematically illustrating a structure of a porous layer and an alignment layer according to Example 1.

FIG. 15 is a sectional view schematically illustrating a structure of a porous layer and an alignment layer according to Example 2.

FIG. 16 is a sectional view schematically illustrating a structure of a porous layer and an alignment layer according to Example 3.

FIG. 17 is a sectional view schematically illustrating a structure of a porous layer and an alignment layer according to Comparative Example 1.

FIG. 18 is a sectional view schematically illustrating a structure of a porous layer and an alignment layer of the liquid crystal device.

FIG. 19 is a flowchart illustrating a method of manufacturing the liquid crystal device.

FIG. 20 is a schematic sectional view illustrating a part of a manufacturing step of the method of manufacturing the liquid crystal device.

FIG. 21 is a schematic sectional view illustrating a part of a manufacturing step of the method of manufacturing the liquid crystal device.

FIG. 22 is a diagram representing a state of a surface of the porous layer.

FIG. 23 is a diagram representing the state of the surface of the porous layer.

FIG. 24 is a diagram representing the state of the surface of the porous layer.

FIG. 25 is a diagram representing the state of the surface of the porous layer.

FIG. 26 is a diagram representing the state of the surface of the porous layer.

FIG. 27 is a schematic sectional view illustrating a part of a manufacturing step of a method of manufacturing a liquid crystal device according to a second embodiment.

FIG. 28 is a schematic sectional view illustrating a part of a manufacturing step of the method of manufacturing the liquid crystal device.

FIG. 29 is a schematic sectional view illustrating a structure of a porous layer and an alignment layer according to a modification example.

### DESCRIPTION OF EXEMPLARY EMBODIMENTS

Hereinafter, embodiments will be described with reference to the accompanying drawings. In each figure, each layer or each member is illustrated at a recognizable scale, and thus, each layer or each member may have a scale different from that in reality.

### First Embodiment

### Liquid Crystal Device

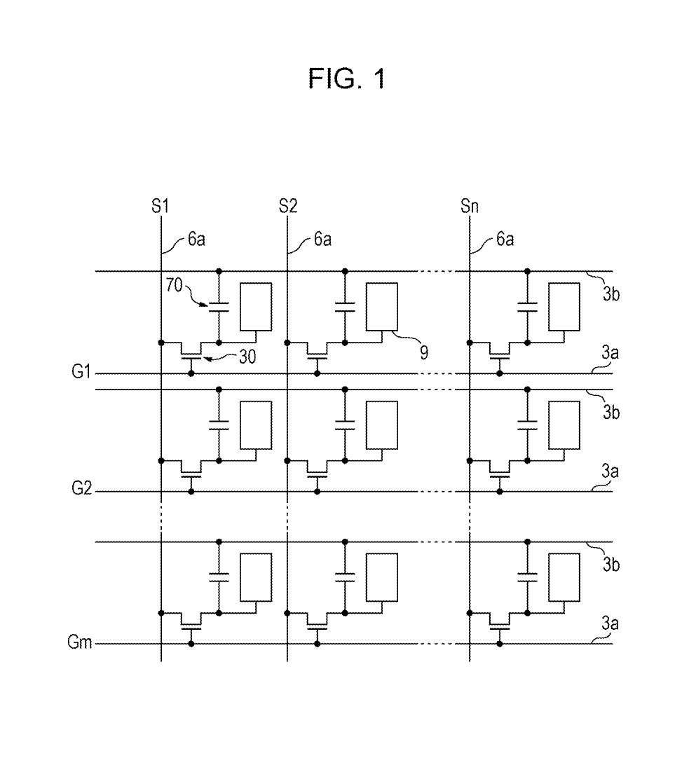

First, a liquid crystal device according to an embodiment will be described with reference to FIG. 1 to FIG. 4.

The liquid crystal device according to the present embodiment is an active matrix transmissive liquid crystal device which uses a thin film transistor (TFT) element as a switching element.

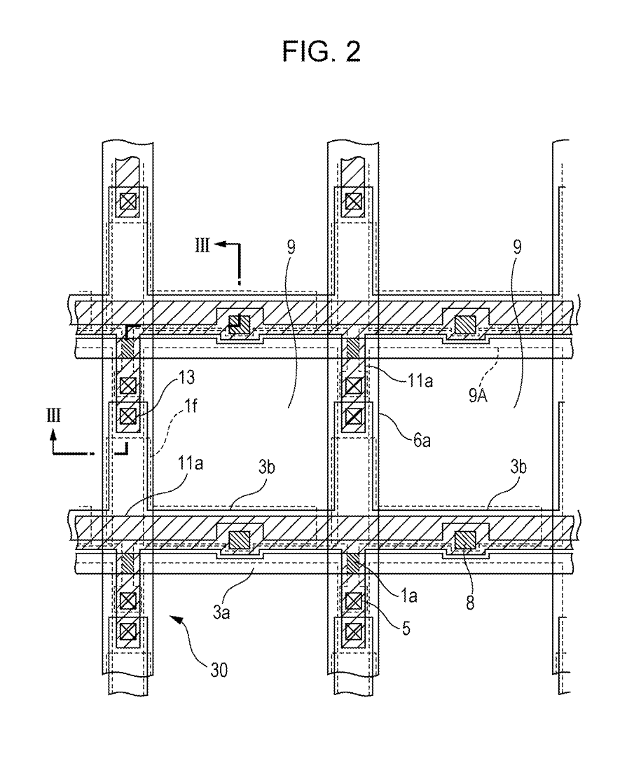

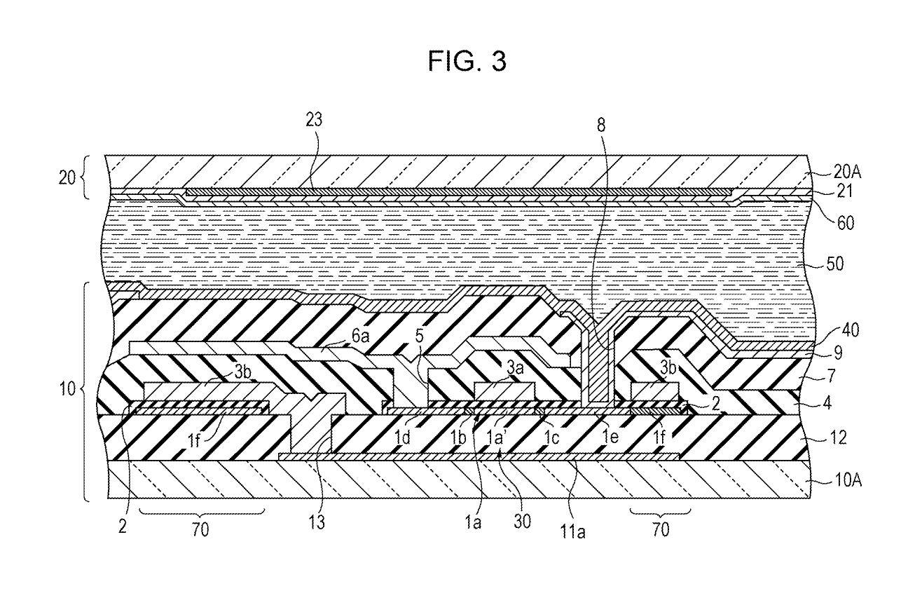

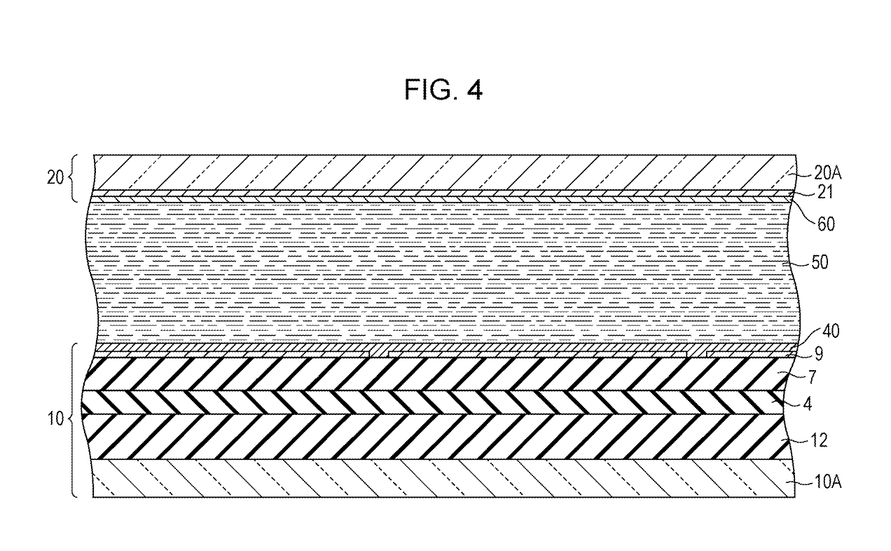

FIG. 1 is an equivalent circuit diagram of switching elements, signal lines, and the like in multiple pixels arranged in a matrix that forms an image display region of the transmissive liquid crystal device according to the present embodiment. FIG. 2 is a plan view illustrating a structure of multiple pixel groups adjacent to each other in a TFT array substrate in which a data line, a scanning line, a pixel electrode, or the like are formed. FIG. 3 is a sectional view illustrating an element region of the transmissive liquid crystal device according to the present embodiment and is a cross-sectional diagram taken along line III-III of FIG. 2. FIG. 4 is a sectional view schematically illustrating multiple pixel regions of the transmissive liquid crystal device according to the present embodiment. FIG. 3 and FIG. 4 illustrate a case in which an upper side of the paper is a light incident side and a lower side of the paper is a viewing side (observer side). In addition, in FIG. 4, some configuration elements such as switching elements are not illustrated so as to ensure suitable viewability of the figure.

As illustrated in FIG. 1, the transmissive liquid crystal device according to the present embodiment includes multiple pixels which form an image display region and are arranged in a matrix. Each pixel includes a pixel electrode 9 and a TFT element 30 that is a switching element for controlling conduction of the pixel electrode 9. In addition, a data line 6a through which an image signal is transmitted is electrically connected to a source of the TFT element 30. Image signals S1, S2, . . . , Sn are applied to the data lines 6a in this order of the data lines, or are applied to the multiple data lines 6a adjacent to each other for each group.

In addition, multiple scanning lines 3a are electrically connected to gates of the TFT elements 30, and scanning signals G1, G2, . . . , Gm are applied to the multiple scanning lines 3a in this order of the scanning lines in a pulsed manner at a predetermined timing. In addition, the pixel electrode 9 is electrically connected to a drain of the TFT element 30, the TFT element 30 that is a switching element is turned on for a predetermined period, and the image signals S1, S2, . . . , Sn supplied from the data lines 6a are written at a predetermined timing.

The image signals S1, S2, . . . , Sn with predetermined levels which are written to a liquid crystal through the pixel electrode 9 are held between the pixel electrode 9 and a common electrode, which will be described below, for a predetermined period. The liquid crystal changes the alignment or order of a set of molecules according to an applied voltage level, thereby modulating light to display a gradation. Here, in order to prevent the held image signal from leaking, a capacitor 70 is added parallel to a liquid crystal capacitor disposed between the pixel electrode 9 and the common electrode.

As illustrated in FIG. 2, the transmissive liquid crystal device according to the present embodiment includes multiple rectangular pixel electrodes 9 (outline is represented by dashed-line section 9A) which are formed of a transparent conductive material such as indium tin oxide (hereinafter, referred to as ITO) on a TFT array substrate and are provided parallel to each other in a matrix. In addition, the data line 6a, the scanning line 3a, and a capacitance line 3b are respectively provided along vertical and horizontal boundaries of the pixel electrode 9. The present embodiment has a structure in which pixels are formed by individual pixel electrodes 9 and regions at which the data lines 6a, the scanning lines 3a, and the capacitance lines 3b are provided to surround each pixel electrode 9, and each pixel disposed in a matrix can perform display.

The data line 6a is electrically connected to a source region, which will be described below, and is formed in a semiconductor layer 1a formed of, for example, a polysilicon film that forms the TFT element 30, through a contact hole 5. The pixel electrode 9 is electrically connected through a contact hole 8 to a drain region which will be describe below and is formed in the semiconductor layer 1a. In addition, the scanning line 3a is disposed in the semiconductor layer 1a so as to face a channel region (hatched region in the top left of FIG. 2) which will be described below. A portion, which faces the channel region, of the scanning line 3a functions as a gate electrode.

The capacitance line 3b includes a main line section (that is, a first region formed along the scanning line 3a in planar view) which extends in an approximately straight line along the scanning line 3a and a protrusion section (that is, a second region which extends along the data line 6a in a planar view) which protrudes toward a front stage side (upward portion of FIG. 2) along the data line 6a from a location which intersects the data line 6a. In addition, multiple first light shielding films 11a are provided in an area represented by hatching in the top right of FIG. 2.

As illustrated in FIG. 3 and FIG. 4, the transmissive liquid crystal device according to the present embodiment includes a TFT array substrate 10 that is formed of a pair of substrates, and a liquid crystal layer 50 which is interposed between the TFT array substrate 10 and a counter substrate 20 disposed opposite to the TFT array substrate 10. The liquid crystal layer 50 is formed of a liquid crystal whose initial alignment state exhibits vertical alignment and which has negative dielectric anisotropy. The transmissive liquid crystal device according to the present embodiment is a display device with a vertical alignment mode.

The TFT array substrate 10 mainly includes a substrate body 10A which is formed of a light-transmissive material such as quartz, the pixel electrode 9 formed on a surface on the liquid crystal layer 50 side of the substrate body 10A, and an alignment layer 40. The counter substrate 20 mainly includes a substrate body 20A formed of a light-transmissive material such as glass or quartz, a common electrode 21 formed on a surface on the liquid crystal layer 50 side thereof, and an alignment layer 60. In addition, in the TFT array substrate 10, the pixel electrode 9 is provided on a surface (inner surface) on the liquid crystal layer 50 side of the substrate body 10A, and the TFT element 30 which performs switching control of each pixel electrode 9 is provided at a location adjacent to the pixel electrode 9.

The TFT element 30 has a lightly doped drain (LDD) structure. Specifically, the TFT element 30 includes the scanning line 3a, a channel region 1a′ of the semiconductor layer 1a in which a channel is formed by an electric field from the scanning line 3a, a gate insulating film 2 which insulates the semiconductor layer 1a from the scanning line 3a, the data line 6a, a low concentration source region 1b and a low concentration drain region 1c of the semiconductor layer 1a, and a high concentration source region 1d and a high concentration drain region 1e of the semiconductor layer 1a.

In addition, a second insulating interlayer 4 in which the contact hole 5 leading to the high concentration source region 1d and the contact hole 8 leading to the high concentration drain region 1e are formed is formed on the substrate body 10A including the scanning line 3a and the gate insulating film 2. That is, the data line 6a is electrically connected to the high concentration source region 1d through the contact hole 5 which passes through the second insulating interlayer 4.

Furthermore, a third insulating interlayer 7, in which the contact hole 8 leading to the high concentration drain region 1e is formed, is formed on the substrate body 10A that includes the data line 6a and the second insulating interlayer 4. That is, the high concentration drain region 1e is electrically connected to the pixel electrode 9 through the contact hole 8 which passes through the second insulating interlayer 4 and the third insulating interlayer 7.

In addition, in the present embodiment, the gate insulating film 2 extends from a location facing the scanning line 3a for being used as a dielectric film, the semiconductor layer 1a extends to be set as a first capacitance electrode 1f, and furthermore, a part of the capacitance line 3b facing the first capacitance electrode if is set as a second capacitance electrode, and thereby a capacitor 70 is formed.

A first light shielding film 11a is provided in a region in which each TFT element 30 is formed, on a surface (inner surface) on the liquid crystal layer 50 side of the substrate body 10A of the TFT array substrate 10. The first light shielding film 11a prevents light which is transmitted to the TFT array substrate 10, reflected by the illustrated lower surface (a boundary between the TFT array substrate 10 and air) of the TFT array substrate 10, and which returns to the liquid crystal layer 50 side from being incident on at least the channel region 1a′, the low concentration source region 1b, and the low concentration drain region 1c of the semiconductor layer 1a.

In addition, a first insulating interlayer 12 for electrically insulating the semiconductor layer 1a, which forms the TFT element 30, from the first light shielding film 11a is formed between the first light shielding film 11a and the TFT element 30.

Furthermore, in addition to providing the first light shielding film 11a in the TFT array substrate 10, the first light shielding film 11a is formed to be electrically connected to the capacitance line 3b in a front stage or a rear stage through a contact hole 13.

In addition, the alignment layer 40 is formed on the liquid crystal layer 50 side of the TFT array substrate 10, that is, on the pixel electrode 9 and the third insulating interlayer 7. The alignment layer 40 controls the alignment of liquid crystal molecules in the liquid crystal layer 50 when a voltage is not applied.

Meanwhile, in the counter substrate 20, a second light shielding film 23 is provided on a surface on the liquid crystal layer 50 side of the substrate body 20A. The second light shielding film 23 covers a region which faces a region in which the data line 6a, the scanning line 3a, and the TFT element 30 are formed, that is, a region other than an opening region of each pixel section, thereby preventing incident light from being incident on the channel region 1a′, the low concentration source region 1b, or the low concentration drain region 1c of the semiconductor layer 1a of the TFT element 30.

Furthermore, the common electrode 21 made of, for example, ITO or the like is formed over approximately the entire surface on the liquid crystal layer 50 side of the substrate body 20A in which the second light shielding film 23 is formed. In addition, the alignment layer 60 is formed on the liquid crystal layer 50 side of the common electrode 21. The alignment layer 60 controls the alignment of liquid crystal molecules in the liquid crystal layer 50 when a voltage is not applied.

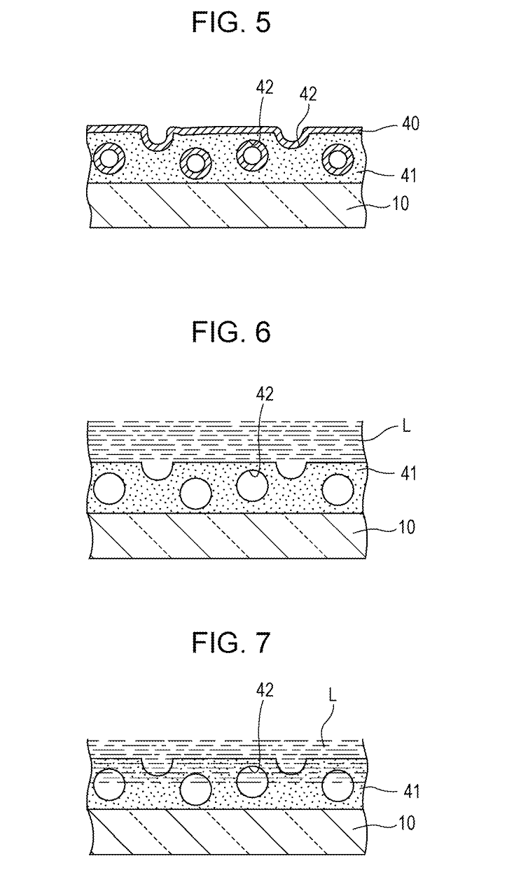

Here, a structure of the alignment layer 40 (60) will be described with reference to FIG. 5. FIG. 5 is a sectional view schematically illustrating the structure of the alignment layer 40 (60). In the present embodiment, a case in which the alignment layer 40 on the TFT array substrate 10 side and the alignment layer 60 on the counter substrate 20 side have the same structure as each other is exemplified. Hence, in FIG. 5, an example in which the alignment layer 40 is used will be described.

As illustrated in FIG. 5, the liquid crystal device according to the present embodiment includes the alignment layer 40 formed of an organosilane compound and a porous layer 41 provided under the alignment layer 40, on a surface of the TFT array substrate 10 on the liquid crystal layer 50 side. The alignment layer 40 is formed, on a surface of the porous layer 41, in a thickness T which is less than a hole diameter Φ of a hole 42 in the porous layer 41 in a state in which the organosilane compound infiltrates into the porous layer 41.

The porous layer 41 is formed of inorganic oxide having multiple holes 42. For example, SiO₂, SnO₂, GeO₂, ZrO₂, TiO₂, Al₂O₃, ITO, or the like can be used as the inorganic oxide.

In case where the porous layer 41 is formed of insulating inorganic oxide such as, SiO₂, SnO₂, GeO₂, ZrO₂, TiO₂, or Al₂O₃, the porous layer 41 can be used as the third insulating interlayer 7.

Meanwhile, in case where the porous layer 41 is formed of conductive inorganic oxide such as ITO, the porous layer 41 can be used as at least a part of an electrode, that is, the pixel electrode 9. In this case, the porous layer 41 is not required to be formed in addition to the pixel electrode 9, and thus, costs are reduced.

The porous layer 41 may have a structure including multiple holes 42. Specifically, the porous layer 41 may have a porous structure in which fine holes (meso holes) are formed of a tissue formed of inorganic oxide. A sol-gel method, a spray method, or the like can be used as a method of forming the porous layer 41 having a porous structure. In a case of the porous layer 41 having the porous structure, an oblique electric field method (PVA), a multi-domain VA method (MVA), a rubbing method, an alignment method such as an optical alignment method can be employed in the alignment layer 40.

In addition, the porous layer 41 may have a column structure in which holes (gaps) are formed between columnar tissues (columns) formed of inorganic oxide. For example, an oblique deposition method or the like can be used as a method of forming the porous layer 41 having a column structure. In a case of the porous layer 41 having a column structure, an alignment method which uses columnar alignment can be employed in the alignment layer 40.

The porous layer 41 illustrated in FIG. 5 is formed as the third insulating interlayer 7 formed of inorganic oxide having a porous structure, on a surface of the pixel electrode 9 on the TFT array substrate 10 side. Meanwhile, the alignment layer 40 illustrated in FIG. 5 is formed in the thickness T less than the hole diameter Φ of the hole 42 in the porous layer 41, on a surface of the porous layer 41, in a state in which the organosilane compound infiltrates into the porous layer 41.

In addition, a solution containing an indium salt and a tin salt is sprayed onto a heated substrate in atmosphere using a spray method, as a method of forming the porous layer 41 formed of ITO. At this time, pyrolysis and crystallization occur, and thus, an ITO thin film is formed. In addition, a porous thin film can be formed corresponding to conditions such as, temperature of a substrate or a spray method. Meanwhile, a coated film is formed by coating the substrate with a solution in which fine particles of ITO are dispersed, is baked, and thus, it is possible to form the porous layer 41 formed of ITO.

It is preferable that the hole diameter Φ of the hole 42 is set to 2 nm to 50 nm on average so as to obtain sufficient permeability in which a coating solution containing the organosilane compound, which will be described below, infiltrates into the porous layer 41 by capillary action. In addition, the hole 42 with the hole diameter Φ in such a range does not affect alignment control of the liquid crystal layer 50 which is performed by the alignment layer 40. The hole diameter Φ of the hole 42 can be measured by using, for example, a scanning electron microscope (SEM), a transmission electron microscopy (TEM), a small angle X-ray scattering method (SAXS), or the like. In addition, a specific surface area and a fine hole distribution of the porous layer 41 can be measured by using a gas adsorption method.

Meanwhile, it is preferable that, since the alignment layer 40 containing the organosilane compound is formed to be an ultrathin film, the thickness T of the alignment layer 40 is set to 1 nm to 10 nm on average. Accordingly, it is possible to obtain effects of suppression of burn-in in a liquid crystal device. The thickness T of the alignment layer 40 can be measured by using, for example, an X-ray photoelectron spectroscopy method (XPS).

As described above, in the liquid crystal device of the present embodiment, the alignment layer 40 of an ultrathin film can be formed on a surface of the porous layer 41 described above, and thus, it is possible to suppress occurrence of burn-in. In addition, it is possible to further increase a light resistance life.

### Method of Manufacturing Liquid Crystal Device

A method of manufacturing a liquid crystal device according to the present embodiment will be described with reference to FIG. 6 to FIG. 9. FIG. 6 to FIG. 9 are sectional views illustrating steps of forming the alignment layer 40 on the surface of the porous layer 41, as characteristic portions of the present manufacturing method.

In order to manufacture the liquid crystal device according to the present embodiment, the TFT array substrate 10 is first manufactured. Specifically, the light-transmissive substrate body 10A formed of glass or the like is prepared, and the above-described first light shielding film 11a, the first insulating interlayer 12, the semiconductor layer 1a, various wires 3a, 3b, and 6a, the insulating films 4 and 7, the pixel electrode 9, and the like are formed on a surface of the substrate body 10A, using a known method. Subsequently, the alignment layer 40 is formed on the third insulating interlayer 7 including the pixel electrode 9, and thereby the TFT array substrate 10 is obtained.

In the manufacturing method according the present embodiment, a coating solution L containing the organosilane compound is applied onto a surface of the porous layer 41 (the third insulating interlayer 7) by using, for example, a spin coating method or the like, as illustrated in FIG. 6. Accordingly, as illustrated in FIG. 7, a coated film P is formed in a state in which the coating solution L infiltrates into the porous layer 41.

In general, when a contact angle with respect to a surface of the substrate is greater than 0 degrees, if a solution applied to the surface of the substrate is less than or equal to a certain thickness, the solution spatters, and this is known by the following equation.

e_{c}=2k⁻¹ sin(θ_{E}/2)

(e_{c}: water-repellent critical thickness, k⁻¹: capillary tube length, and θ_{E}: contact angle)

Since the alignment layer 40 formed of the organosilane compound is an ultrathin film on the order of nanometers (nm), a “spattering phenomenon” of the coating solution L occurs during formation of the alignment layer 40. The “spattering phenomenon” is considered to be a cause in which the solution L agglomerates and becomes droplets.

In contrast to this, in the manufacturing method according to the present embodiment, the solution L containing the organosilane compound infiltrates into the porous layer 41 by capillary action. At this time, if a thickness of the coated film P covering a surface of the porous layer 41 is less than the diameter of the hole 42 in the porous layer 41, it is possible to prevent the solution from agglomerating and becoming droplets.

The thickness of the coated film P depends upon the amount of coating of the coating solution L containing the organosilane compound. The amount of coating of the coating solution L can be controlled by concentration of the organosilane compound, presence/absence of an acid catalyst, viscosity of the solution, coating conditions (for example, the number of rotation of spin coating), or the like.

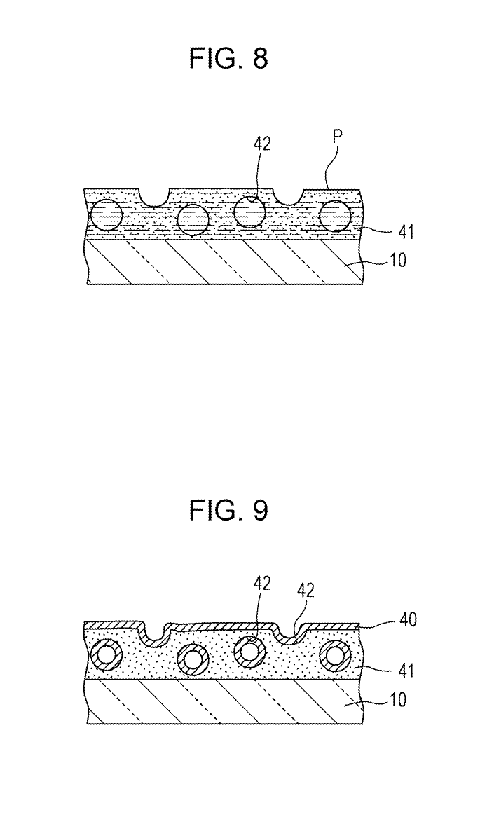

Thereafter, as illustrated in FIG. 8, the coated film P is dried (precured), and thereafter, is baked (postcured) to be cured. Accordingly, as illustrated in FIG. 9, it is possible to form the alignment layer 40 with a thickness less than the diameter of the hole 42 in the porous layer 41, on the surface of the porous layer 41. After the alignment layer 40 is formed, alignment processing with respect to the alignment layer 40 is performed if necessary.

Subsequently, the counter substrate 20 is manufactured separately from the aforementioned TFT array substrate 10. Specifically, after the light-transmissive substrate body 20A formed of glass or the like is prepared, the second light shielding film 23 and the common electrode 21 are formed on a surface of the substrate body 20A by using a method in the same manner as in case in which the TFT array substrate 10 is manufactured, and the alignment layer 60 is formed by using a method in the same manner as in case where the aforementioned alignment layer 40 is formed. Hence, the counter substrate 20 is obtained.

Subsequently, the TFT array substrate 10 and the counter substrate 20 are bonded to each other by a sealing agent. Furthermore, liquid crystal with negative dielectric anisotropy is injected through a liquid crystal inlet formed in the sealing agent, and thereby a liquid crystal panel is produced, and thereafter, predetermined wires are connected to the liquid crystal panel. Accordingly, it is possible to manufacture the liquid crystal device according to the present embodiment.

As described above, in the manufacturing method according to the present embodiment, the coating solution L containing the aforementioned organosilane compound infiltrates into the porous layer 41 by capillary action. At this time, the thickness of the coated film P formed on the surface of the porous layer 41 is less than the diameter of the hole 42 in the porous layer 41, and thus, it is possible to prevent the coating solution applied on the surface of the porous layer from agglomerating and becoming droplets.

Accordingly, it is possible to form as an ultrathin film the coated film P containing the organosilane compound on the surface of the porous layer 41. Thereafter, the coated film P is dried, baked, and thus, it is possible to form the alignment layer 40 with a thickness less than the diameter of the hole 42 in the porous layer 41, on the surface of the porous layer 41, in a state in which the organosilane compound infiltrates into the porous layer 41.

Hence, according to the manufacturing method of the present embodiment, the alignment layer 40 with a more uniform thickness can be formed on the surface of the porous layer 41, and thus it is possible to suppress occurrence of burn-in in the manufactured liquid crystal device.

The disclosure is not limited to the embodiments, and various modifications can be made within a range without departing from the spirit.

For example, in the present embodiment, only an active matrix liquid crystal device which uses TFT elements is described, but the disclosure is not limited to this, and can also be applied to, for example, an active matrix liquid crystal device which uses a thin film diode (TFD) element, a passive matrix liquid crystal device, or the like. In addition, in the present embodiment, only a transmissive liquid crystal device is described, but the disclosure is not limited to this, and can also be applied to a reflection type liquid crystal device, and a semi-transmissive and reflection type liquid crystal device. In this way, the disclosure can also be applied to liquid crystal devices having any type of structure.

### Electronic Apparatus

An example of an electronic apparatus including the liquid crystal device according to the embodiment will be described.

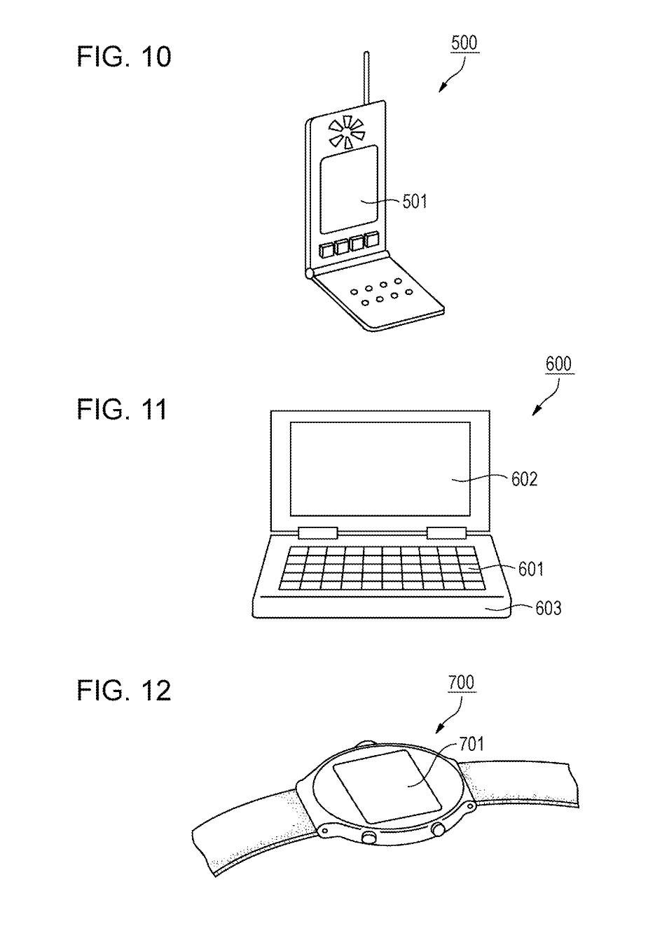

FIG. 10 is a perspective view illustrating an example of a mobile phone. The mobile phone illustrated in FIG. 10 includes a mobile phone body 500, and the mobile phone body 500 includes a liquid crystal display unit 501 which uses the liquid crystal device according to the embodiment.

FIG. 11 is a perspective view illustrating an example of an information processing device 600 such as a word processor or a personal computer. The information processing device 600 includes an input unit 601 such as a key board, and an information processing device body 603 having a liquid crystal display unit 602 that uses the liquid crystal device according to the present embodiment, as illustrated in FIG. 11.

FIG. 12 is a perspective view illustrating an example of a watch. The watch illustrated in FIG. 12 includes a watch body 700, and the watch body 700 includes a liquid crystal display unit 701 which uses the liquid crystal device according to the embodiment.

As described above, in the respective electronic apparatuses illustrated in FIG. 10 to FIG. 12, the liquid crystal device according to the embodiment is applied to the display units, and thus, it is possible to suppress occurrence of burn-in, and to maintain display quality for a long time.

The liquid crystal device according to the present embodiment can be suitably used for an electronic apparatus, in which the increase of a light resistance life is desired, such as digital signage (electronic signage) or a projector (projection type liquid crystal display device), in addition to the electronic apparatuses illustrated in FIG. 10 to FIG. 12. In addition, the embodiment can also be suitably used for a liquid crystal device such as a liquid crystal lens or an optical pick-up element which uses the liquid crystal lens.

### Projection Type Liquid Crystal Display Device

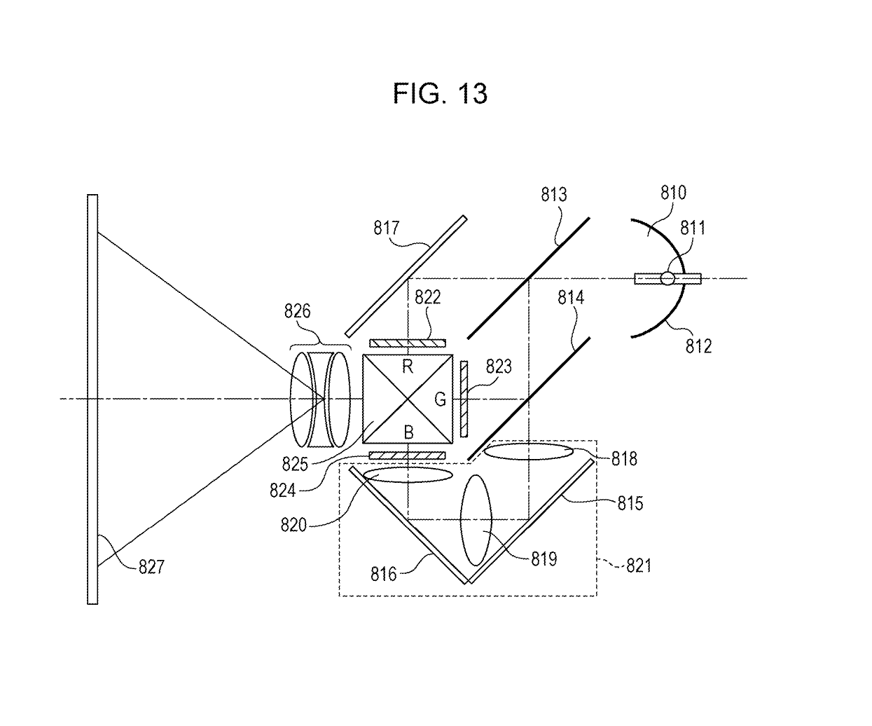

A configuration of a projection type liquid crystal display device (projector) including the liquid crystal device according to the present embodiment as a light modulation unit will be described with reference to FIG. 13. FIG. 13 is a schematic configuration view illustrating a main portion of the projection type liquid crystal display device which uses the liquid crystal device according to the embodiment as a light modulation device.

The projection type liquid crystal display device illustrated in FIG. 13 includes a light source 810, dichroic mirrors 813 and 814, a reflection mirrors 815, 816, and 817, an incident lens 818, a relay lens 819, an emission lens 820, liquid crystal light modulation devices 822, 823, and 824, a cross dichroic prism 825, and a projection lens 826.

The light source 810 is formed by a lamp 811 such as a metal halide lamp, and a reflector 812 which reflects the light of a lamp. The dichroic mirror 813 which reflects blue light and green light transmits red light and reflects blue light and green light among light beams from the light source 810. The transmitted red light is reflected by the reflection mirror 817, and is incident on the liquid crystal light modulation device 822 for red light which includes the liquid crystal device according to the present embodiment.

Meanwhile, green light which is reflected by the dichroic mirror 813 is reflected by the dichroic mirror 814 for reflecting green light, and is incident on the liquid crystal light modulation device 823 for green light which includes the liquid crystal device that is an example of the aforementioned embodiment. Blue light also is transmitted through the second dichroic mirror 814. In order to compensate for the blue light having a length of a light path different from those of the green light and the red light, a light guiding unit 821, which is formed with a relay lens system including the incident lens 818, the relay lens 819, and the emission lens 820, is provided, and the blue light is incident on the liquid crystal light modulation device 824 for blue light including the liquid crystal device which is an example of the aforementioned embodiment through the light guiding unit 821.

The light of three colors modulated by each light modulation device is incident on the cross dichroic prism 825. The cross dichroic prism 825 is formed by bonding four right angle prisms, and a dielectric multilayer film which reflects the red light and a dielectric multilayer film which reflects the blue light are provided therein in a cross shape. The light of three colors is synthesized by the dielectric multilayer films, and light which represents a color image is formed. The light which is synthesized is projected onto a screen 827 by the projection lens 826 which is a projection optical system, and the color image is enlarged to be displayed.

According to the projection type liquid crystal display device having the aforementioned structure, the liquid crystal device according to the embodiment is applied to the liquid crystal light modulation devices 822, 823, and 824, and thus, it is possible to suppress occurrence of burn-in, and to maintain display quality for a long time.

### EXAMPLE

The effects of the embodiment become more apparent by examples below. The embodiment is not limited to the following examples, and can be implemented by being suitably modified in a range without departing from the gist of the embodiment.

### Example 1

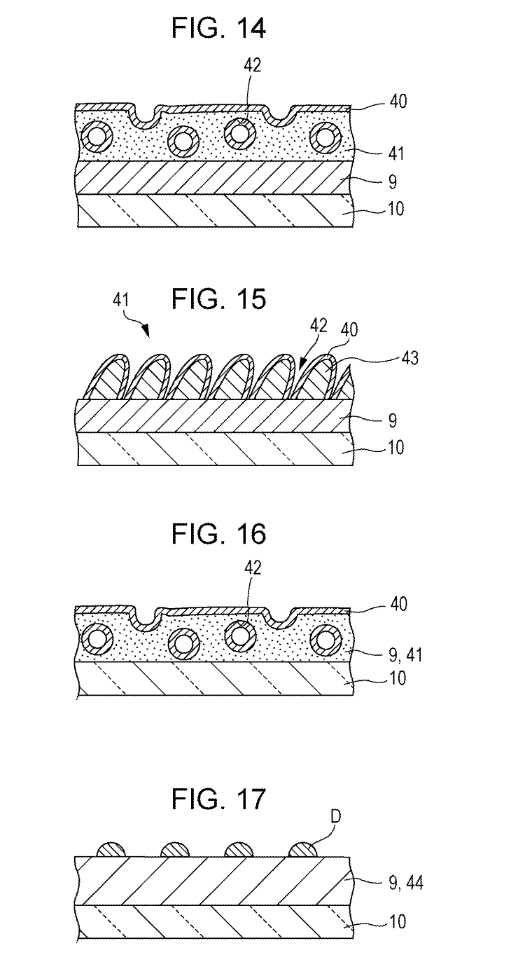

In Example 1, the porous layer 41 with a porous structure having the fine hole (meso hole) 42 in a tissue formed of silicon oxide (SiOₓ) was formed on a surface of the pixel electrode 9 on the TFT array substrate 10 side, using a sol-gel method, as illustrated in FIG. 14. The average of the diameters of the holes 42 was measured to be approximately 4 nm. Fine holes were distributed at intervals of 6 nm or less.

Subsequently, a coating solution was prepared by mixing decyltrimethoxysilane, an organic solvent, and an acid catalyst, and then a coated film was formed by applying the coating solution onto the surface of the porous layer 41, using a spin coating method. It was confirmed that the coated film was formed in a state in which the coating solution infiltrated into the porous layer 41. Thereafter, the coated film was dried and baked, and thereby the alignment layer 40 was formed.

The average thickness of the alignment layer 40 according to the Example 1 was measured to be approximately 2 nm on the surface of the porous layer 41. Accordingly, it can be seen that the alignment layer 40 with a thickness less than the diameter of the hole 42 in the porous layer 41 is formed. In addition, when observing the surface of the alignment layer 40, marks of agglomerated droplets (hereinafter, referred to as droplet marks) were not visible.

### Example 2

In Example 2, the porous layer 41 with a column structure having the hole (interval) 42 between columnar tissues (column) 43 formed of silicon oxide (SiOₓ) was formed on a surface of the pixel electrode 9 on the TFT array substrate 10 side, using an oblique deposition method, as illustrated in FIG. 15. The average diameter of the hole 42 was measured to be approximately 10 nm. Fine holes were distributed at intervals of 50 nm or less.

Subsequently, a coating solution was prepared by mixing decyltrimethoxysilane, an organic solvent, and an acid catalyst, and then a coated film was formed by applying the coating solution onto the surface of the porous layer 41, using a spin coating method. It was confirmed that the coated film was formed in a state in which the coating solution infiltrated into the porous layer 41. Thereafter, the coated film was dried and baked, and thereby the alignment layer 40 was formed.

The average thickness of the alignment layer 40 according to Example 2 was measured to be approximately 2 nm on the surface of the porous layer 41. Accordingly, it can be seen that the alignment layer 40 with a thickness less than the diameter of the hole 42 in the porous layer 41 is formed. In addition, when observing the surface of the alignment layer 40, marks of agglomerated droplets (hereinafter, referred to as droplet marks) were not visible.

### Example 3

In example 3, the porous layer 41 formed of ITO was formed as the pixel electrode 9 on the TFT array substrate 10 side, as illustrated in FIG. 16. Specifically, the porous layer 41 with a porous structure having the fine hole (meso hole) 42 in a tissue formed of ITO was formed by using a spray method. The average diameter of the hole 42 was measured to be approximately 10 nm. The fine holes were distributed at intervals of 50 nm or less.

Subsequently, a coating solution was prepared by mixing decyltrimethoxysilane, an organic solvent, and an acid catalyst, and then a coated film was formed by applying the coating solution onto the surface of the porous layer 41 (the pixel electrode 9), using a spin coating method. It was confirmed that the coated film was formed in a state in which the coating solution infiltrated into the porous layer 41. Thereafter, the coated film was dried and baked, and thereby the alignment layer 40 was formed.

The average thickness of the alignment layer 40 according to Example 2 was measured to be approximately 2 nm on the surface of the porous layer 41. Accordingly, it can be seen that the alignment layer 40 with a thickness less than the diameter of the hole 42 in the porous layer 41 is formed. In addition, when observing the surface of the alignment layer 40, marks of agglomerated droplets (hereinafter, referred to as droplet marks) were not visible.

### Comparative Example 1

In Comparative Example 1, a non-porous layer 44 formed of ITO was formed as the pixel electrode 9 on the TFT array substrate 10 side, as illustrated in FIG. 17. Subsequently, a coating solution was prepared by mixing decyltrimethoxysilane, an organic solvent, and an acid catalyst, and then a coated film was formed by applying the coating solution onto the surface of the non-porous layer 44 (the pixel electrode 9), using a spin coating method. It was confirmed that the coated film containing droplets was formed by agglomerating the coating solution applied on the surface of the non-porous layer 44. Thereafter, the coated film was dried and baked, and thereby the alignment layer 40 was formed.

Multiple droplet marks D were observed when observing a surface of the alignment layer 40 according to the first comparative example. In addition, since the droplets were agglomerated in multiple droplet marks D, the average thickness of the alignment layer 40 was not able to be measured.

In order to measure the average thickness of the alignment layer 40 and the average diameter of the hole 42, the substrate was first cut, and images of ten substrates were acquired by using a scanning electron microscope (SEM), in conditions in which an acceleration voltage was 5 kV and measurement magnification was 150,000 times, while an observation position was changed.

Subsequently, in order to obtain the average thickness of the alignment layer 40, five points were assigned per image which was acquired, the thickness of the porous layer 41 and thicknesses of the porous layer 41 and the alignment layer 40 were measured, the average value of the respective thicknesses was calculated, and thereafter, the difference therebetween was set as an average thickness of the alignment layer 40.

Meanwhile, in order to obtain the average diameter of the hole 42, ten points were assigned per image which was acquired, a width of the hole 42 on the surface of the porous layer 41 was measured, and the average value of the respective widths was set as an average diameter of the hole 42.

### Second Embodiment

### Liquid Crystal Device

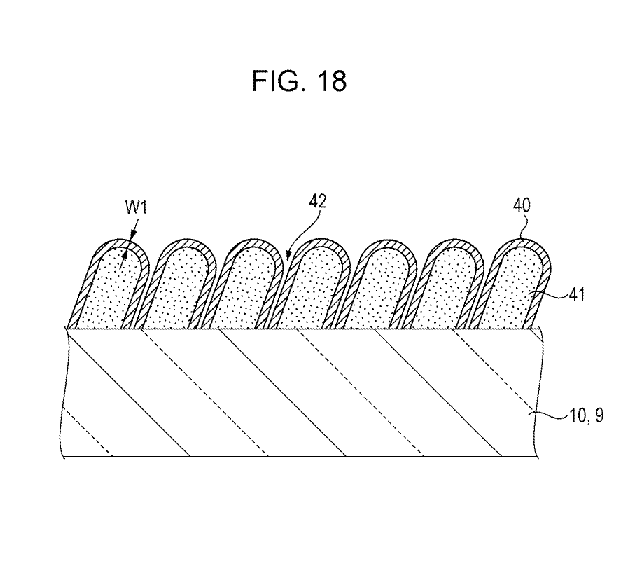

Here, a structure of the alignment layer 40 (60) according to a second embodiment will be described with reference to FIG. 18. FIG. 18 is a sectional view schematically illustrating a structure of the alignment layer 40 (60). In the present embodiment, a case in which the alignment layer 40 on the TFT array substrate 10 side and the alignment layer 60 on the counter substrate 20 side have the same structure as each other is exemplified. Hence, the alignment layer 40 will be described as an example in FIG. 18.

In addition, structures of a porous layer and an alignment layer of a liquid crystal device according to the second embodiment are different from those of the liquid crystal device according to the first embodiment described above, and the other portions are approximately the same as each other. Therefore, in the second embodiment, portions different from those of the first embodiment will be described in detail, and description of the other similar portions will be appropriately omitted.

The liquid crystal device according to the second embodiment includes the alignment layer 40 formed of the organosilane compound on a surface of the TFT array substrate 10 on the liquid crystal layer 50 side, and the porous layer 41 provided under the alignment layer 40, as illustrated in FIG. 18. The alignment layer 40 is formed with a thickness W1 less than the diameter of the hole 42 between the porous layers 41 on the surface of the porous layer 41, in a state in which the organosilane compound is accumulated on the surface of the porous layer 41.

The porous layer 41 is formed of inorganic oxide. For example, SiO₂, SnO₂, GeO₂, ZrO₂, TiO₂, Al₂O₃, ITO, or the like can be used as the inorganic oxide.

In case where the porous layer 41 is formed of insulating inorganic oxide such as, SiO₂, SnO₂, GeO₂, ZrO₂, TiO₂, or Al₂O₃, the porous layer 41 can be used as a third insulating interlayer 7.

Meanwhile, in case where the porous layer 41 is formed of conductive inorganic oxide such as ITO, the porous layer 41 can be used as at least a part of an electrode, that is, the pixel electrode 9. In this case, the porous layer 41 need not be formed in addition to the pixel electrode 9, and thus, costs can be reduced.

In the present embodiment, the porous layer 41 has a column structure in which the hole 42 (hole diameter) is formed between columnar tissues (columns) formed of inorganic oxide. For example, an oblique deposition method or the like can be used as a method of forming the porous layer 41 having the column structure. In case where the porous layer 41 has a column structure, an alignment method of aligning holes in a column shape can be employed for the alignment layer 40.

The porous layer 41 illustrated in FIG. 18 is formed as a third insulating interlayer 7 formed of inorganic oxide, on the surface of the pixel electrode 9 on the TFT array substrate 10 side. Meanwhile, the alignment layer 40 illustrated in FIG. 18 is formed with the thickness T less than the diameter of the hole 42 between the porous layers 41 on the surface of the porous layer 41, in a state in which the organosilane compound is accumulated on the surface of the porous layer 41.

It is preferable that the diameter of the hole 42 is set to 2 nm to 50 nm on average so as to obtain a sufficient diameter for a chemical bond between the organosilane compound in which vapor phase reaction is performed and the surface of the porous layer 41. In addition, with the hole diameter of the range, the hole 42 does not adversely affect the alignment control of a liquid crystal layer 50 which is performed by the alignment layer 40. The diameter of the hole 42 can be measured by using, for example, a scanning electron microscope (SEM), a transmission electron microscopy (TEM), a small angle X-ray scattering method (SAXS), or the like.

Meanwhile, it is preferable that the thickness T of the alignment layer 40 is set to 1 nm to 10 nm on average so as to form the ultrathin alignment layer 40 containing the organosilane compound. Accordingly, it is possible to obtain effects of suppressing occurrence of burn-in in the liquid crystal device. The thickness T of the alignment layer 40 can be measured by using, for example, an X-ray photoelectron spectroscopy (XPS) method.

As described above, in liquid crystal device according to the present embodiment, the ultrathin alignment layer 40 can be formed on the surface of the aforementioned porous layer 41, and thus, it is possible to suppress occurrence of burn-in. In addition, it is possible to further increase a light resistance life.

### Method of Manufacturing Liquid Crystal Device

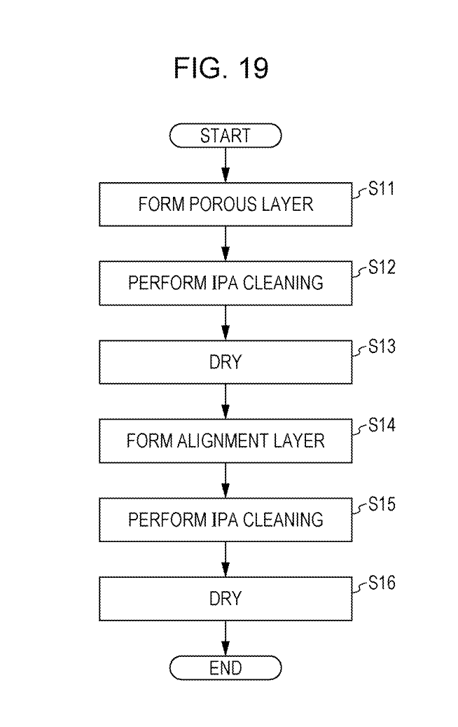

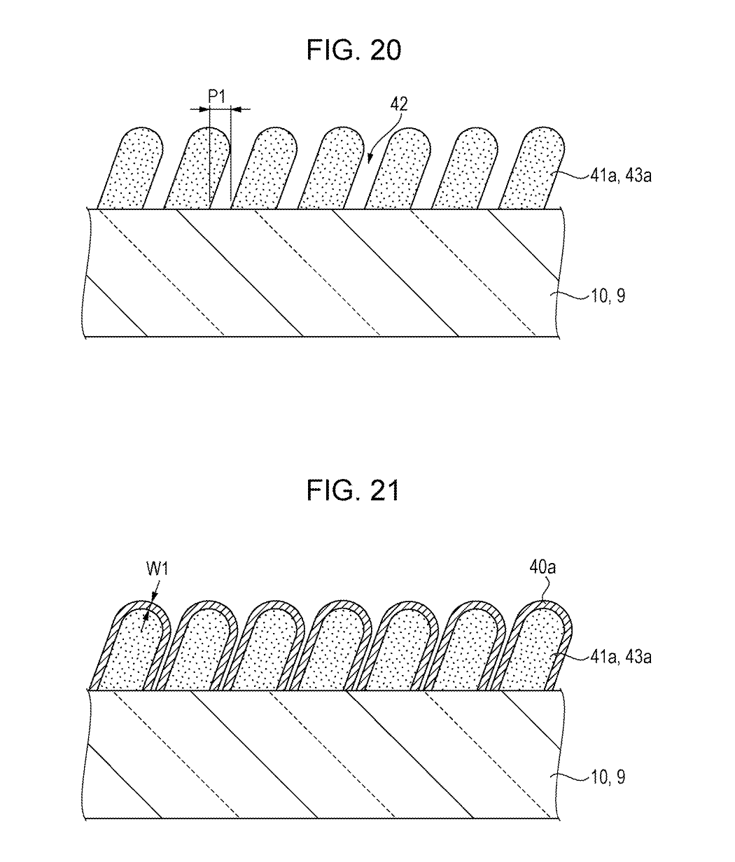

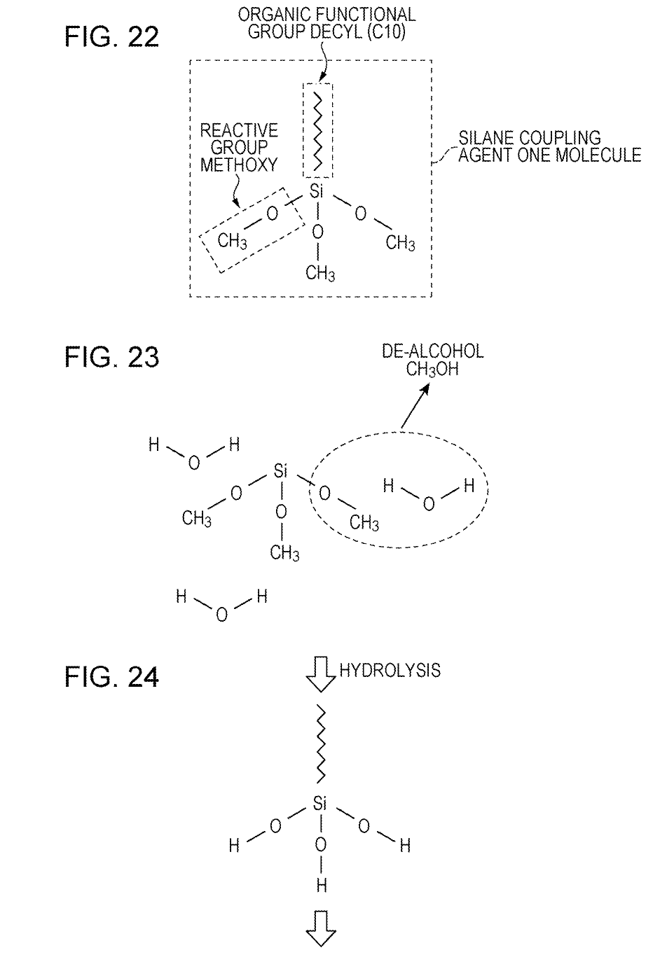

A method of manufacturing the liquid crystal device according to the second embodiment will be described with reference to FIG. 19 to FIG. 26. FIG. 19 is a flowchart illustrating a method of manufacturing the liquid crystal device. FIG. 20 and FIG. 21 are schematic sectional views illustrating a part of manufacturing steps of a method of manufacturing the liquid crystal device. FIG. 22 to FIG. 26 are diagrams representing a state of the surface of the porous layer. Hereinafter, the method of manufacturing the liquid crystal device according to the second embodiment will be described with reference to FIG. 18 to FIG. 26.

When manufacturing the liquid crystal device according to the second embodiment, the TFT array substrate 10 is first made. Specifically, the light-transmissive substrate body 10A formed of glass or the like is prepared, and the aforementioned first light shielding film 11a, the first insulating interlayer 12, the semiconductor layer 1a, the respective wires 3a, 3b, and 6a, the insulating films 4 and 7, the pixel electrode 9, and the like are formed on the surface of the substrate body 10A, using a known method (refer to FIG. 3). Here, the substrate which is formed up to the pixel electrode 9 is referred to as the TFT array substrate 10.

First, in step S11, a porous layer 41a is formed as illustrated in FIG. 19. Specifically, the porous layer 41a is formed on the surface of the pixel electrode 9 of the TFT array substrate 10, as illustrated in FIG. 7.

Subsequently, the porous layer 41 with a columnar structure having the hole 42 (hole diameter P1) between columns 43a of a column shape formed of silicon oxide (SiOₓ) or the like is formed on the surface of the pixel electrode 9 on the TFT array substrate 10 side, using an oblique deposition method.

Specifically, the porous layer 41 having six layers is formed by repeating an oblique deposition process. Vacuum degree is 5E⁻³ (Pa), a deposition rate is 15 (angstrom/sec), and an elevation angle is 48°. The average hole diameter (hole diameter P1 of the hole 42) of the columns 43 is, for example, 7 nm. The holes are distributed at intervals of 2 nm to 50 nm.

In step S12, IPA cleaning is performed. Specifically, the TFT array substrate 10 on which the porous layer 41 is formed is moved to an isopropyl alcohol (IPA) cleaning bath, and impurities attached to the TFT array substrate 10 are removed.

In step S13, drying is performed. Specifically, the TFT array substrate 10 is dried in a vacuum chamber which is heated to 150° C. for approximately one hour.

In step S14, the alignment layer 40a is formed. Specifically, decyltrimethoxysilane which is the organosilane compound is vaporized (vapor phase reaction) to be sprayed in a vacuum chamber which is heated to 150° C., thereby being attached and accumulated on the surface of the TFT array substrate 10, as illustrated in FIG. 8. Furthermore, unreacted decyltrimethoxysilane is discharged. This film forming step is repeated five times.

Thereafter, the TFT array substrate 10 is moved into a vacuum state of 150° C. and vacuum dry processing is performed for the TFT array substrate 10 for three hours. By doing so, decyltrimethoxysilane which is accumulated in the TFT array substrate 10 without reaction (without bond) is vaporized again and discharged.

Hereinafter, steps of forming the alignment layer 40 will be described by using chemical formulas (chemical reaction) with reference to FIG. 22 to FIG. 26. First, silane coupling processing is performed on the surface of the porous layer 41a. Specifically, for example, carrier gas containing vaporized silane coupling agent (refer to FIG. 22) is introduced into a film forming chamber. In addition, moisture is supplied to the film forming chamber, and thereby the silane coupling agent and moisture are combined and alcohol is emitted (de-alcohol), as illustrated in FIG. 23. Then, a part of a methoxy group is hydrolyzed (Refer to FIG. 24).

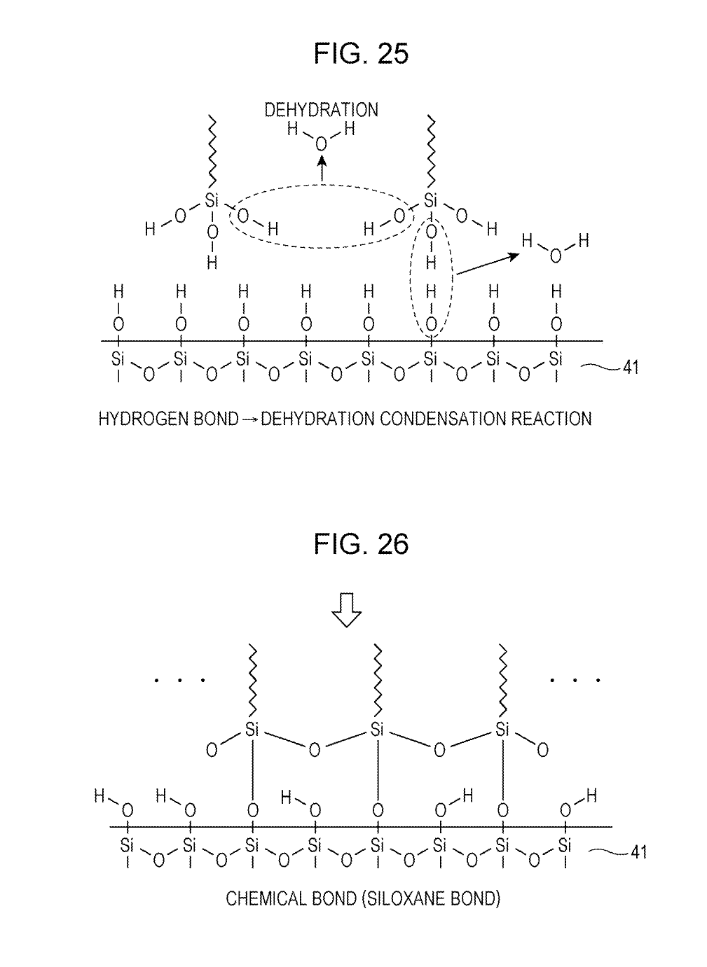

Thereafter, the hydrolyzed silane coupling agent reacts with a hydroxyl group on the surface of the porous layer 41a (41). Then, dehydration condensation reaction is made via hydrogen bonding, as illustrated in FIG. 25. The silane coupling agent is chemically bonded with the hydroxyl group on the surface of the porous layer 41a (41), as illustrated in FIG. 26 (siloxane bond).

In step S15, IPA cleaning is performed. Specifically, the TFT array substrate 10 is moved into the IPA cleaning bath, and immersion cleaning accompanied by swing is performed for ten minutes. By doing so, decyltrimethoxysilane which is unreacted and is not removed is removed.

In step S16, drying is performed. Specifically, the alignment layer 40 is formed by performing drying and baking.

A molecular length of the decyltrimethoxysilane is approximately 2 nm to 3 nm in a longitudinal direction. When an ultrathin film made of a monolayer is formed, a thickness of the ultrathin film is similar to the molecular length, in case where the length in the longitudinal direction of molecules is perpendicular to the porous layer 41. In case where the molecules falls most along a tilted structure or the like, a thickness of the ultrathin film is approximately 1 nm which is shorter than the molecular length. In the present example, the average thickness thereof is approximately 2 nm on the surface of the porous layer 41. Hence, the alignment layer 40 is formed with the thickness W1 less than the diameter (hole diameter P1) of the hole 42 of the porous layer 41 (column 43).

As the alignment layer 40 is formed as described above, it is possible to suppress accumulation of unreacted decyltrimethoxysilane in the TFT array substrate 10, and to suppress occurrence of burn-in in the manufactured liquid crystal device. Specifically, if the thickness of the alignment layer 40 which covers the surface of the porous layer 41 is less than the diameter of the hole 42 (hole diameter P1 of the column 43) of the porous layer 41, it is possible to further suppress accumulation of unreacted decyltrimethoxysilane.

Subsequently, the counter substrate 20 is prepared separately from the TFT array substrate 10. Specifically, the light-transmissive substrate body 20A formed of glass or the like is prepared, and thereafter, the second light shielding film 23 and the common electrode 21 are formed by using the same method as in case where the TFT array substrate 10 is made, and the alignment layer 60 is formed by using the same method as in case where the porous layer 41a and the alignment layer 40 are formed, on the surface of the substrate body 20A, and thereby the counter substrate 20 is obtained (refer to FIG. 3).

Subsequently, the TFT array substrate 10 and the counter substrate 20 are bonded together by a sealing agent. Furthermore, liquid crystal with negative dielectric anisotropy is injected through a liquid crystal inlet formed in the sealing agent, and thereafter predetermined wires are connected. By doing so, the liquid crystal device according to the present embodiment can be manufactured.

In association with the average thickness of the alignment layer 40 and the average diameter of the hole 42, a substrate is first cut, ten images thereof are acquired by using a scanning electron microscope (SEM), in conditions in which an acceleration voltage is 5 kV and measurement magnification is 150,000 times, while an observation position is changed.

In order to obtain the average thickness of the alignment layer 40, five points are assigned per image which is acquired, and the thickness of the porous layer 41 and the thickness of the porous layer 41 and the alignment layer 40 are measured, the average values of the respective thicknesses are calculated, and thereafter, a difference therebetween is set as an average thickness of the alignment layer 40.

In order to obtain the average diameter of the hole 42, ten points are assigned per image which is acquired, the width of the hole 42 on the surface of the porous layer 41 is measured, and the average value of the respective widths is set as an average diameter of the hole 42. In addition, a range of variation of the respective widths is set as hole distribution.

According to the method of manufacturing the liquid crystal device of the second embodiment, the alignment layer 40a with a thickness less than the diameter (hole diameter P1) of the hole 42 in the porous layer 41a is formed. Accordingly, it is possible to chemically bond decyltrimethoxysilane in which vapor phase reaction is performed to the surface (for example, hydroxyl group) of the porous layer 41a, and to suppress accumulation of unreacted decyltrimethoxysilane on the surface of the porous layer 41a. Hence, it is possible to form the ultrathin alignment layer 40a on the surface of the porous layer 41a, and to suppress occurrence of burn-in in the manufactured liquid crystal device.

According to the method of manufacturing the liquid crystal device of the second embodiment, isopropyl alcohol (IPA) cleaning is performed before or after the alignment layer 40a is formed, and thus, it is possible to remove residue attached to the surface of the porous layer 41a or unreacted decyltrimethoxysilane from the surface of the substrate.

### Third Embodiment

### Method of Manufacturing Liquid Crystal Device

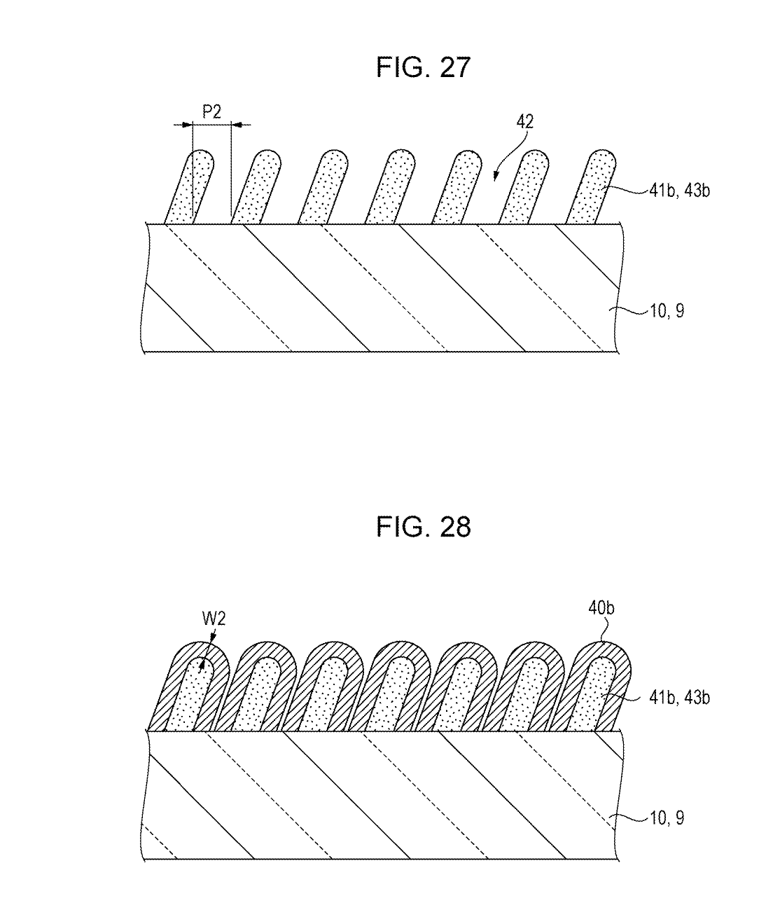

FIG. 27 and FIG. 28 are schematic sectional views illustrating a part of manufacturing steps of a method of manufacturing a liquid crystal device according to a third embodiment. Hereinafter, the method of manufacturing the liquid crystal device according to the third embodiment will be described with reference to FIG. 27 and FIG. 28.

The method of manufacturing the liquid crystal device according to the third embodiment is different from the method of manufacturing the liquid crystal device according to the aforementioned second embodiment, in a method of forming a porous layer and an alignment layer, and the other portions are approximately the same as each other. Therefore, in the third embodiment, portions different from those of the second embodiment will be described in detail, and description of the other similar portions will be appropriately omitted.

In a step illustrated in FIG. 27, a porous layer 41b is formed on the TFT array substrate 10 which is formed up to having the pixel electrode 9. Specifically, a porous layer 41b with a columnar structure having the hole 42 (hole diameter P2) between columns 43b of a column shape formed of silicon oxide (SiOₓ) with six layers or the like is formed on the surface of the pixel electrode 9 on the TFT array substrate 10 side, using an oblique deposition method.

Specifically, vacuum degree is 7E⁻³ (Pa), a deposition rate is 13 (angstrom/sec), and an elevation angle is 48°. In other words, the vacuum degree decreases and furthermore, the deposition rate becomes low, compared to the first embodiment. Accordingly, the average hole diameter (hole diameter P2 of the hole 42) of columns 43b is, for example, 15 nm. The holes are distributed at intervals of 2 nm to 50 nm.

In this way, the deposition conditions of the third embodiment are different from those of the first embodiment, and thereby the hole diameter (hole diameter P2) changes, and a possibility in which pre-tilt occurs increases. That is, the hole diameter (hole diameter P2) becomes larger (be in a state of roughness), but a portion which becomes shadow of one porous layer is widened, and furthermore, density of the film also decreases. Accordingly, there is more difficulty in that organosilane molecules infiltrate in a wraparound manner and covers.

In the step illustrated in FIG. 28, an alignment layer 40b is formed. Specifically, hexadecyltrimethoxysilane as the organosilane compound is vaporized, sprayed in a vacuum chamber heated to 150° C., and is accumulated on the surface of the TFT array substrate 10. Furthermore, unreacted hexadecyltrimethoxysilane is discharged. The film forming step is repeated ten times.

Thereafter, the TFT array substrate 10 is moved into vacuum of 150° C. and vacuum dry processing is performed for the TFT array substrate 10 for three hours. By doing so, hexadecyltrimethoxysilane which is accumulated on the TFT array substrate 10 without reaction (without bond) is vaporized again and discharged. Thereafter, IPA cleaning, drying, and baking are performed in the same manner as in the first embodiment.

A molecular length of the hexadecyltrimethoxysilane is approximately 4 nm to 5 nm in a longitudinal direction. When an ultrathin film made by a monolayer is formed, a thickness of the ultrathin film is similar to the molecular length, in case where the length in the longitudinal direction of molecules is perpendicular to the porous layer 41. The average thickness of the ultrathin film is approximately 5 nm on the surface of the porous layer 41. Hence, the alignment layer 40b is formed with a thickness W2 less than the diameter (hole diameter P2) of the hole 42 of the porous layer 41 (column 43).

Specifically, a network is formed by repeatedly depositing long molecules on the porous layer 41b having the hole 42 which is not easily covered, and thereafter, unbonded molecules in a state of being accumulated are vaporized, washed, and then removed. Hence, it is possible to suppress unreacted hexadecyltrimethoxysilane agglomerating on the TFT array substrate 10, and to suppress alignment being disturbed.

Since the alignment layer 40b may have multiple bonds in which materials are connected to each other, the range of the thickness of the alignment layer 40b is not limited to 2 nm to 5 nm which are described above, and can be expanded up to approximately 1 nm to 10 nm.

According to the method of manufacturing the liquid crystal device of the second embodiment, the alignment layer 40b with a thickness less than the diameter (hole diameter P2) of the hole 42 in the porous layer 41b is formed. Accordingly, it is possible to chemically bond hexadecyltrimethoxysilane in which vapor phase reaction is performed to the surface (for example, hydroxyl group) of the porous layer 41b, and to suppress unreacted hexadecyltrimethoxysilane being accumulated on the surface of the porous layer 41b. Hence, it is possible to form the ultrathin alignment layer 40b on the surface of the porous layer 41b, and to suppress occurrence of burn-in in the manufactured liquid crystal device.

The aspects of the disclosure are not limited to the aforementioned embodiments, can be appropriately modified in a range without departing from the gist or spirit of the disclosure which is obtained from the claims and the entire specification, and is included in the technical range of the aspect of the disclosure. In addition, the disclosure can be implemented in the following aspect.

### Modified Example 1

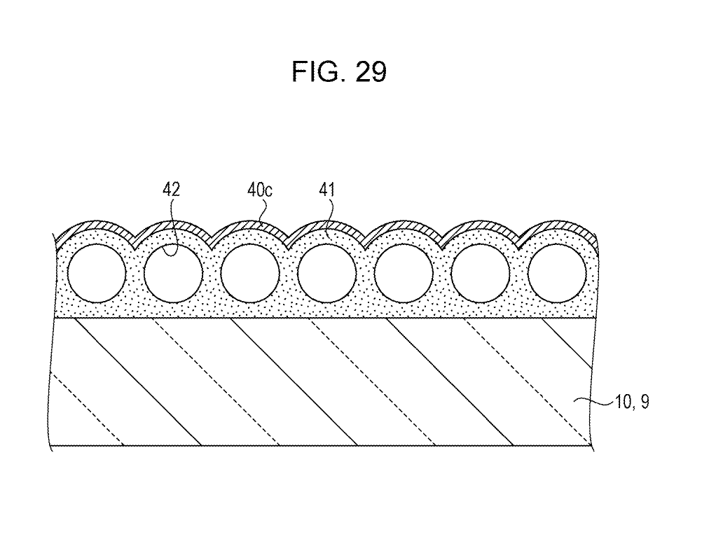

As described above, the porous layer 41 is not limited to the structure which is formed by using an oblique deposition method, may have a structure in which the hole 42 is regularly disposed, and for example, may have the structure illustrated in FIG. 29. FIG. 29 is a schematic sectional view illustrating a structure of a porous layer and an alignment layer according to a modification example.

As illustrated in FIG. 29, a porous layer 41c includes the holes 42 which are regularly arranged. A surface of the porous layer 41c has a wave shape according to the shape of the hole 42. An alignment layer 40c is formed on the surface of the porous layer 41c by using vapor phase reaction. Even in this structure, the alignment layer 40c with a thickness less than the diameter of the hole 42 in the porous layer 41c is formed. Accordingly, it is possible to chemically bond the vaporized organosilane compound to the surface (for example, hydroxyl group) of the porous layer 41c, and to suppress unreacted organosilane compound being accumulated on the surface of the porous layer 41c. Hence, it is possible to form the ultrathin alignment layer 40c on the surface of the porous layer 41c, and to suppress occurrence of burn-in in the manufactured liquid crystal device.

### Modification Example 2

As described above, an active matrix liquid crystal device which uses TFT elements is described, but the embodiment can also be applied to, for example, an active matrix liquid crystal device which uses thin film diode (TFD) elements, a passive matrix liquid crystal device, or the like. In addition, in the present embodiment, a transmissive liquid crystal device is described, but the embodiment can also be applied to a reflection type liquid crystal device (LCOS) which uses a silicon substrate or the like, or a semi-transmission and reflection type liquid crystal device.

The entire disclosures of Japanese Patent Application No. 2015-066734 filed Mar. 27, 2015 and 2015-248275 filed Dec. 21, 2015 are expressly incorporated by reference herein.

What is claimed is:

1. A method of manufacturing a liquid crystal device comprising:
providing a substrate which includes a porous layer on a surface of the substrate;
applying a coating solution containing a organosilane compound to a surface of the porous layer;
forming a coated film, in a state in which the coating solution infiltrates the porous layer;
drying the coated film; and
baking the coated film so as to be formed an alignment layer on the surface of the porous layer,
wherein the alignment layer having a thickness less than a diameter of a hole in the porous layer.

2. The method of manufacturing a liquid crystal device according to claim 1, wherein the porous layer is formed by using a sol-gel method.

3. The method of manufacturing a liquid crystal device according to claim 1, wherein an average thickness of the alignment layer is 1 nm to 10 nm.

4. The method of manufacturing a liquid crystal device according to claim 1, wherein an average diameter of the hole is 2 nm to 50 nm.

5. The method of manufacturing a liquid crystal device according to claim 1, wherein an inorganic oxide film selected from SiO₂, SnO₂, GeO₂, ZrO₂, TiO₂, Al₂O₃, and ITO is formed as the porous layer.

6. A liquid crystal device comprising:
a substrate which includes a porous layer on a surface of the substrate; and
an alignment layer formed on a surface of the porous layer, the alignment layer includes a organosilane compound,
wherein the organosilane compound is infiltrated in the porous layer, and
a thickness of the alignment layer is less than a diameter of a hole in the porous layer.

7. The liquid crystal device according to claim 6, wherein the porous layer forms at least a part of an electrode.

8. An electronic apparatus comprising:
the liquid crystal device manufactured by using the method according to claim 1.

9. An electronic apparatus comprising:
the liquid crystal device according to claim 6.

10. A method of manufacturing a liquid crystal device comprising:
providing a substrate which includes a porous layer on a surface of the substrate; and
performing, on a surface of the porous layer, a vapor phase reaction of gas which contains the organosilane compound so as to be formed an alignment layer on the surface of the porous layer,
wherein the alignment layer having a thickness less than a diameter of a hole in the porous layer.

11. The method of manufacturing a liquid crystal device according to claim 10, wherein the porous layer is formed by using an oblique deposition method.

12. The method of manufacturing a liquid crystal device according to claim 10, wherein an average thickness of the alignment layer is 1 nm to 10 nm.

13. The method of manufacturing a liquid crystal device according to claim 10, wherein an average diameter of the hole is 2 nm to 50 nm.

14. The method of manufacturing a liquid crystal device according to claim 10, wherein an inorganic oxide film selected from SiO₂, SnO₂, GeO₂, ZrO₂, TiO₂, Al₂O₃, and ITO is formed as the porous layer.

15. The method of manufacturing a liquid crystal device according to claim 10, wherein cleaning with isopropyl alcohol (IPA) is performed at least before or after the alignment layer is formed.

16. An electronic apparatus comprising:
a liquid crystal device manufactured by using the method according to claim 10.
